(19) United States
(12) Patent Application Publication
(10) Pub. No.: US 2009/0025441 A1
(43) Pub. Date: Jan. 29, 2009

(54) Device for actively threatening extrinsic destruction of a lock

(75) Inventor: Chih-Sheng Wang, Taipei City (TW)

Correspondence Address: BUCKNAM AND ARCHER, 1077 NORTHERN BOULEVARD, ROSLYN, NY, 11576, US

(73) Assignee: Kuang-Huan FU, Wu Jie Village (TW)

(21) Appl. No.: 11/880,608

(22) Filed: Jul. 23, 2007

(51) Int. Cl. E05B 17/00

(52) U.S. Cl. 70/431

(57) ABSTRACT

The present invention relates to a device for actively threatening extrinsic destruction of a lock which is formed by a male member and a female member, wherein the device comprises a plurality of container units formed by rigid and brittle materials, such as plastic or glass materials and having a pressurized tear gas or toxic gas filled therein to form sealed structures that are inserted in a space in the female member or the male member, and several alarming marks or characters are marked on a surface of the lock. In such manner, when the lock is subjected to an extrinsic destruction, the deformation of the female member or the male member resulted from the extrinsic destruction will squash the sealed container units to instantly eject the pressurized tear gas or toxic gas out.

### BACKGROUND OF THE INVENTION

1. Field of the Invention

The present invention relates to a device for preventing lock from been damaged, and more particularly to a device using a threatening means to prevent outside intruder from damaging a lock.

2. Brief Description of the Prior Art

Generally, a lock such as a door lock, a lock for motorcycle, a lock for bicycle or lock for car basically serves for inactive and passive defense purpose, which can only guard against men of integrity instead of unexpected villains. If a thief means to break the lock, even the toughest lock falls short of enough protection in withstanding such destruction.

In order to improve the defect of easily suffering from being destructed, a prior art of Taiwanese Patent No. M283885 entitled “picklock prevention device”, as shown in FIGS. 6a and 6b, discloses a door lock, comprising a lock device (10′) mounted on a door panel, and the lock device (10′) further includes an actuation rod (11′) and a male member (12′) interlinked with the actuation rod (11′); and a female member (20′) which has a latch groove (21′) mounted on a doorframe. The male member (12′) has a smooth arc surface (122′) on the front side, and a straight urging surface (121′) on the rear side. The male member (12′) is allowed to slide smoothly into the latch groove (21′) of the female member (20′) so as to be retained therein in the forward direction of the relative motion between the male member (12′) and the female member (20′). The door lock further has a picklock preventing element (14′) provided within the male member (12′), one end of the picklock preventing element (14′) constitutes a smooth abutting section (145′) and the other end constitutes a stopper section (143′), the middle portion between the two ends storing the potential energy of a spring (15′) in such a manner that an abutting section (145′) projects toward an urging surface (121′) and the stopper section (143′) retracts back into the male member (12′) all the time. When the male member (12′) is retained in the latch groove (21′) of the female member (20′), the stopper section (143′) projects toward the smooth surface (122′) of the male member (12′) in the reverse direction to abut against the side wall (221′) of the latch groove (21′) so that the picklock resulting from outside intrusion is prevented.

However, the above disclosure still belongs to the inactive defense purpose in spite of one more protection added to the door lock structure. One skilled in the art can understand if a thief means to destroy the lock, there is little chance we can hold it back. Therefore, conventional lock still has lots of rooms for improvement.

### SUMMARY OF THE INVENTION

The main object of the present invention is to provide a device using a threatening means to prevent outside intruder from damaging a lock such that the defect of easily suffering from being destructed can be improved.

In order to achieve the above and another objects, the device for actively threatening extrinsic destruction of a lock of the present invention comprises: a plurality of container units formed by rigid and brittle materials, such as plastic or glass materials, and having a pressurized tear gas or toxic gas filled therein to form sealed structures that are inserted in the spaces in the female member or in the male member, and several alarming marks or characters marked on conspicuous places of the lock.

In this manner, if the alarming marks or characters marked on the surface of lock fails to threaten the outside intruder and the lock is still subjected to extrinsic destruction, the deformation of the female member or the male member resulted from the extrinsic destruction will squash the sealed container units to instantly eject the pressurized tear gas or toxic gas out.

### BRIEF DESCRIPTION OF THE DRAWINGS

FIGS. 1a˜1e are schematic perspective views showing the appearances and structures of the container units of the device for actively threatening extrinsic destruction of a lock of the present invention, wherein FIG. 1a shows a spherical body of the container unit, FIG. 1b shows a cubic body of the container unit, FIG. 1c shows a cylindrical body of the container unit, FIG. 1d shows an elliptical body of the container unit, and FIG. 1e shows a rectangular body of the container unit;

FIG. 2 is a perspective view showing an embodiment of the present invention applicable to a lock of motorcycle or bicycle;

FIG. 3 is a perspective view showing an embodiment of the present invention applicable to a door lock;

FIG. 4 is a perspective view showing an embodiment of the present invention applicable to a car lock;

FIG. 5 is a perspective view showing an embodiment of the present invention applicable to a door lock;

FIG. 6a shows a partial perspective view of a prior art entitled “picklock prevention device for a door lock” of Taiwanese Patent No. M283885; and

FIG. 6b is a schematic cross-sectional view of FIG. 6a.

### DETAILED DESCRIPTION OF THE PREFERRED EMBODIMENTS

The technical features of the present invention will become more apparent through the detailed description of following embodiments, which are merely illustrative rather than restrictive on the scope of the present invention, in conjunction with the attached drawings.

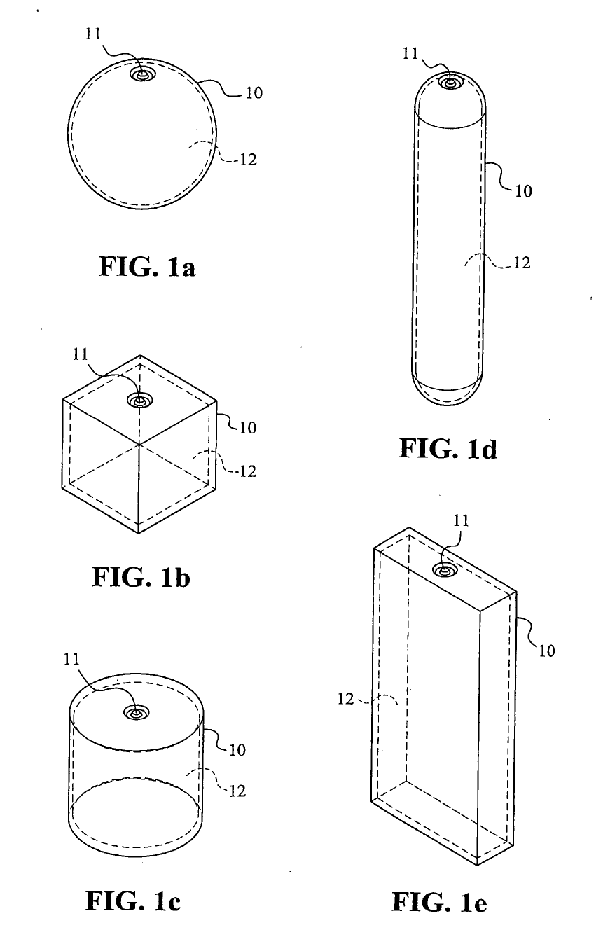

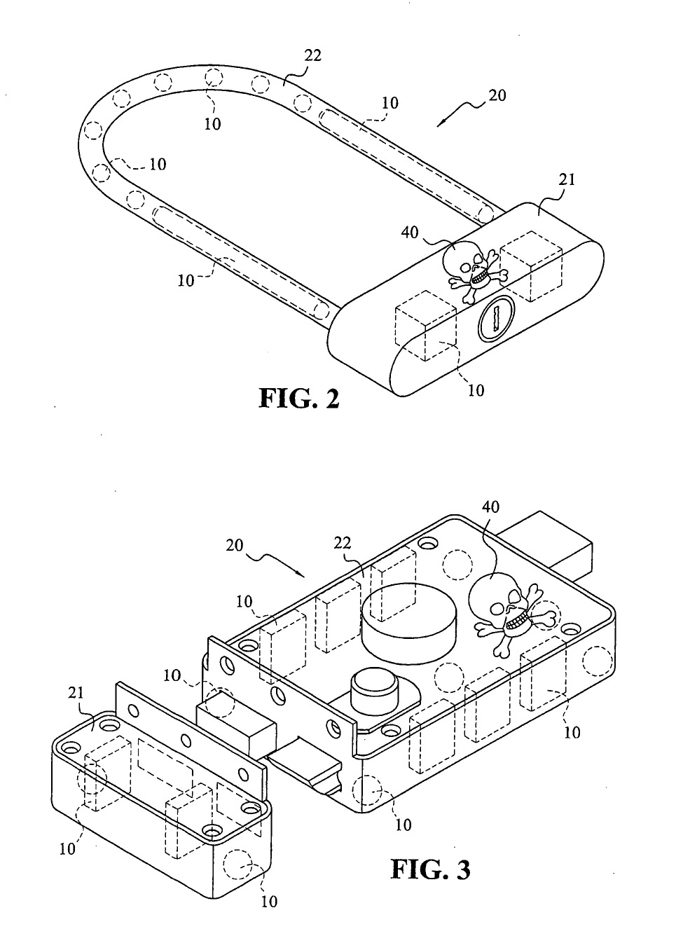

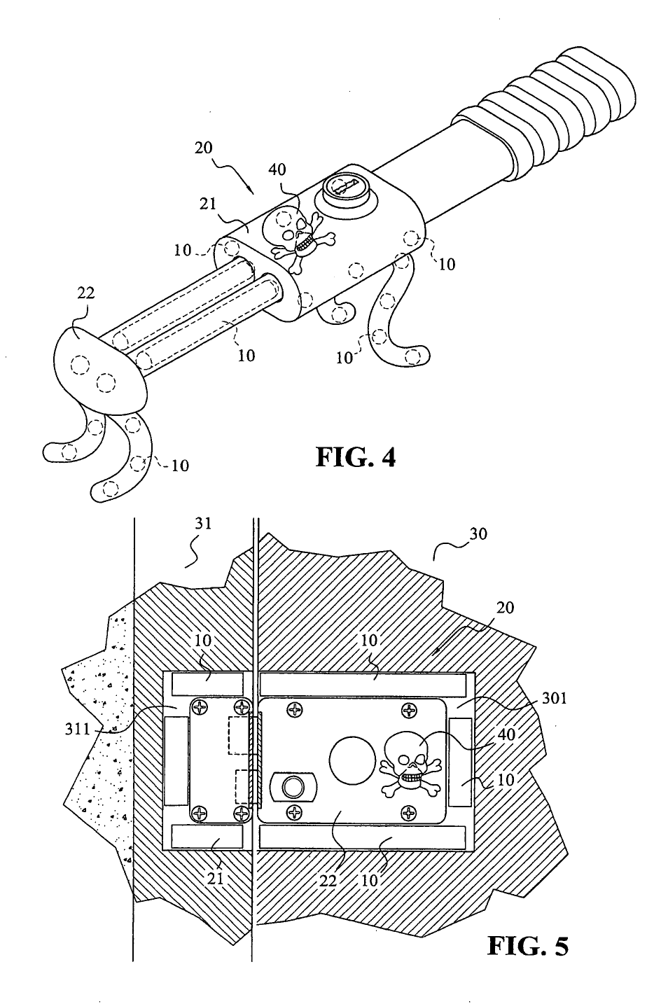

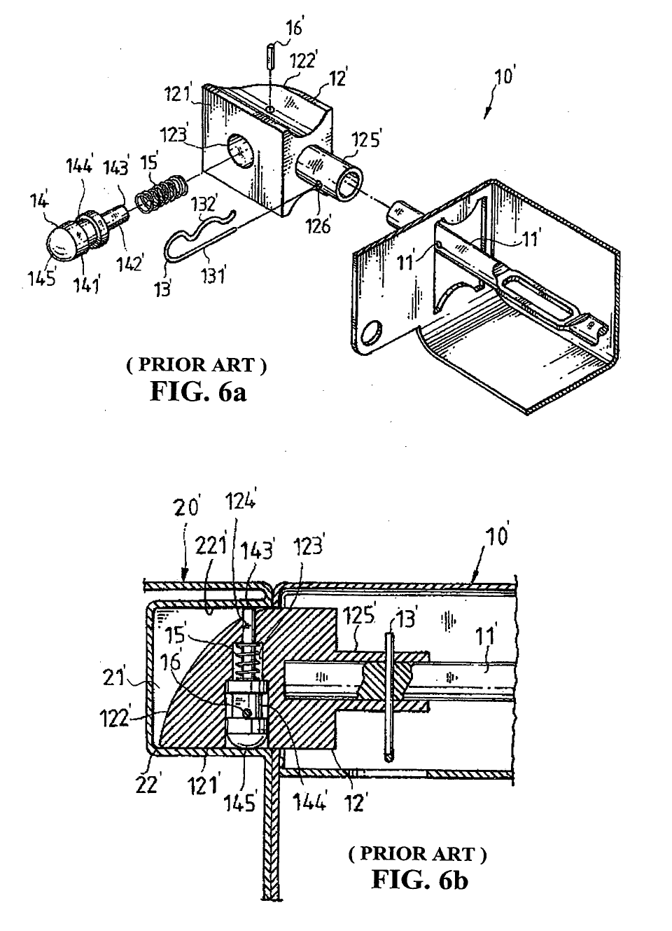

FIGS. 1a˜1e are embodiments showing the container units of the device for actively threatening extrinsic destruction of a lock of the present invention. FIG. 2 shows a first embodiment of the present invention applicable to a lock of motorcycle or bicycle. FIG. 3 shows a second embodiment of the present invention applicable to a door lock. FIG. 4 shows a third embodiment of the present invention applicable to a car lock. FIG. 5 shows a fourth embodiment of the present invention applicable to a door lock. According to the present invention, the lock device 20 comprises a female member 21, a male member 22, and a plurality of container units 10 disposed in the interior space of the female member 21 and the male member 22. Preferably, the shape of the container unit is, for example, a spherical body as shown in FIG. 1a, a cubic body as shown in FIG. 1b, a cylindrical body as shown in FIG. 1c, an elliptical body as shown in FIG. 1d, a rectangular body as shown in FIG. 1e, or any shape which is adaptive to the space filling. The container unit 10 has an interior space 2 in which a pressurized anaerobic gas such as a tear gas or a toxic gas is filled through a filling opening 11, and the filling opening 11 is closed after the gas filling and the container unit 10 is thus formed as a sealed structure.

According to the present invention, the container unit 10 is preferably formed by rigid and brittle materials, such as plastic or glass materials, which can withstand light extrusion or impact, and the container units 10 with suitable shape, size and quantities are inserted in the female member 21 or the male member 22, or are inserted in the spaces in the two members 21, 22. Furthermore, some alarming marks 40 represented by patterns or characters are marked on conspicuous places of the surface of the lock device 20.

FIG. 2 shows a first embodiment of the present invention applicable to a lock of motorcycle or bicycle. An ordinary lock device 20 for motorcycle or bicycle basically consists of a female member 21 and a male member 22. In the present invention, a plurality of container units 10 having suitable size, shape and quantities are inserted in the interior spaces in the female member 21 and the male member 22, and several alarming marks 40 or characters (not shown in FIG. 2) are marked on the surface of the lock device 20. In such manner, if the alarming marks or characters marked on the surface of lock device 20 fail to threaten the outside intruder and the lock is still subjected to the extrinsic destruction, the deformation of the female member 21 or the male member 22 resulted from the extrinsic destruction will squash the sealed container units 10 to instantly eject the pressurized tear gas or toxic gas out.

FIG. 3 shows a second embodiment of the present invention applicable to a door lock. An ordinary door lock 20 basically consists of a female member 21 and a male member 22. In the present invention, a plurality of container units 10 having suitable size, shape and quantities are inserted in the interior spaces of the female member 21 and the male member 22, and several alarming marks 40 or characters (not shown in FIG. 3) are marked on the surface of the door lock 20. In such manner, if the alarming marks or characters marked on the surface of door lock 20 fail to threaten the outside intruder and the door lock 20 is still subjected to the extrinsic destruction, the deformation of the female member 21 or the male member 22 resulted from the extrinsic destruction will squash the sealed container units 10 to instantly eject the pressurized tear gas or toxic gas out.

FIG. 4 shows a third embodiment of the present invention applicable to a car lock. An ordinary car lock 20 basically consists of a female member 21 and a male member 22. In the present invention, a plurality of container units 10 having suitable size, shape and quantities are inserted in the interior spaces of the female member 21 and the male member 22, and several alarming marks 40 or characters (not shown in FIG. 4) are marked on the surface of the car lock 20. In such manner, if the alarming marks or characters marked on the surface of car lock 20 fail to threaten the outside intruder and the car lock 20 is still subjected to the extrinsic destruction, the deformation of the female member 21 or the male member 22 resulted from the extrinsic destruction will squash the sealed container units 10 to instantly eject the pressurized tear gas or toxic gas out.

FIG. 5 shows a fourth embodiment of the present invention applicable to a door lock. In this embodiment, the door lock 20 includes a female member 21 mounted on a doorframe 31 and a male member 22 correspondingly mounted on a door panel 30. A space 311 is reserved in the doorframe 31 along the periphery of the female member 21, and a space 301 is also reserved in a door panel 30 along the periphery of the male member 30. A plurality of container units 10, with suitable size, shape and quantities, formed by rigid and brittle materials and having an anaerobic gas filled therein to form sealed structures that are inserted in the spaces 301, 311 along the peripheries of the female member 21 and the male member 20, and several alarming marks 40 or characters (not shown in the FIG. 5) are marked on the surface of the door lock 20. In such manner, if the alarming marks or characters marked on the surface of car lock 20 fail to threaten the outside intruder and the car lock 20 is still subjected to the extrinsic destruction, the deformation of the female member 21 or the male member 22 resulted from the extrinsic destruction will squash the sealed container units 10 to instantly eject the pressurized tear gas or toxic gasd out.

The above embodiments is for the illustrative purpose only, not for the restriction of the scope of the present invention. The equivalent modifications and variations made without departing from the spirit and principle of the present invention are considered to be still within the scope of the present invention.

What is claimed is:

1. A device for actively threatening extrinsic destruction of a lock formed by a male member and a female member, comprising:
a plurality of container units having a high-pressure anaerobic gas filled therein to form a plurality of sealed structure and disposed in a space around said female member or said male member and ejecting said high-pressure anaerobic gas when said lock is destructed extrinsically and one of said female member and said male member is deformed to squash said plural sealed container units.

2. A device for actively threatening extrinsic destruction of a lock according to claim 1, wherein said container unit is selected from a group consisting of a spherical body, a cylindrical body, a cubic body, a rectangular body and an elliptical body.

3. A device for actively threatening extrinsic destruction of a lock according to claim 2, wherein said container unit is formed by one of a plastic material and a glass material.

4. A device for actively threatening extrinsic destruction of a lock according to claim 3, wherein said lock device is one of a lock for motorcycle and a lock for bicycle.

5. A device for actively threatening extrinsic destruction of a lock according to claim 3, wherein said lock device is a door lock.

6. A device for actively threatening extrinsic destruction of a lock according to claim 1, wherein said high-pressure anaerobic gas is a tear gas.

7. A device for actively threatening extrinsic destruction of a lock according to claim 1, wherein said high-pressure anaerobic gas is a toxic gas.

8. A device for actively threatening extrinsic destruction of a lock according to claim 1, wherein one of a plurality of alarming marks and a plurality of alarming characters are marked on a surface of said lock.

9. A device for actively threatening extrinsic destruction of a lockhaving at least a female member mounted on a doorframe and a male member correspondingly mounted on a door panel, wherein a space is reserved in said doorframe along a periphery of said female member, and a space is reserved in a door panel along a periphery of said male member, a plurality of container units having a high-pressure anaerobic gas filled therein to form a plurality of sealed structures and disposed in a space around said female member and said male member respectively, and ejecting said high-pressure anaerobic gas when said lock is destructed extrinsically and one of said female member and said male member is deformed to squash said plural sealed container units.

10. A device for actively threatening extrinsic destruction of a lock according to claim 11, wherein said container unit is selected from a group consisting of a spherical body, a cylindrical body, a cubic body, a rectangular body and an elliptical body.

11. A device for actively threatening extrinsic destruction of a lock according to claim 10, wherein said container unit is formed by one of a plastic material and a glass material.

12. A device for actively threatening extrinsic destruction of a lock according to claim 11, wherein said lock device is a door lock.

13. A device for actively threatening extrinsic destruction of a lock according to claim 9, wherein said anaerobic gas is a tear gas.

14. A device for actively threatening extrinsic destruction of a lock according to claim 9, wherein said anaerobic gas is a toxic gas.

15. A device for actively threatening extrinsic destruction of a lock according to claim 9, wherein a plurality of alarming marks or a plurality alarming characters are marked on a surface of said lock.
